(19) United States
(12) Patent Application Publication
(10) Pub. No.: US 2025/0365758 A1
(43) Pub. Date: Nov. 27, 2025

(54) METHOD AND APPARATUS FOR LOW LATENCY COMMUNICATION IN WIRELESS LAN SUPPORTING MULTIPLE LINKS

(71) Applicants: HYUNDAI MOTOR COMPANY, Seoul (KR); KIA CORPORATION, Seoul (KR); Korea National University of Transportation Industry-Academic Cooperation Foundation, Chungju-si, Chungcheongbuk-do (KR)

(72) Inventors: Yong Ho Kim, Incheon (KR); Ju Seong Moon, Osan-si, Gyeonggi-do (KR)

(73) Assignees: HYUNDAI MOTOR COMPANY, Seoul (KR); KIA CORPORATION, Seoul (KR); Korea National University of Transportation Industry-Academic Cooperation Foundation, Chungju-si, Chungcheongbuk-do (KR)

(21) Appl. No.: 18/874,524

(22) PCT Filed: Jul. 4, 2023
(86) PCT No.: PCT/KR2023/009398

§ 371 Date: Dec. 12, 2024

(30) Foreign Application Priority Data
Jul. 4, 2022 (KR) 10-2022-0081955

(51) Int. Cl. H04W 74/04; H04W 56/00; H04W 84/12

(52) U.S. Cl. CPC H04W 74/04; H04W 56/001; H04W 84/12

(57) ABSTRACT

A method and apparatus for low latency communication in a wireless LAN supporting multiple links are disclosed. The method of a first device comprises the steps of: identifying an SP that is set in a second link; and communicating with a second device in a first link before the start time of the SP, wherein the communication between the first device and the second device ends before the start time of the SP.

### TECHNICAL FIELD

The present disclosure relates to a wireless local area network (LAN) communication technique, and more particularly, to a technique for channel access based on a restricted target wake time (R-TWT) in a dense wireless LAN environment.

### BACKGROUND ART

Recently, as the spread of mobile devices expands, a wireless local area network technology capable of providing fast wireless communication services to mobile devices is in the spotlight. The wireless LAN technology may be a technology that supports mobile devices such as smart phones, smart pads, laptop computers, portable multimedia players, embedded devices, and the like to wirelessly access the Internet based on wireless communication technology.

The IEEE 802.11ac standard has expanded bandwidths used (e.g., a maximum 160 MHz bandwidth or 80+80 MHz bandwidth) and also increased the number of supported spatial streams. The IEEE 802.11ac standard may refer to a very high throughput (VHT) wireless LAN technology that can support a data rate of over 1 gigabit per second (Gbps). The IEEE 802.11ac standard can utilize MIMO techniques to support downlink transmissions to multiple stations.

As applications requiring higher throughput and applications requiring real-time transmission occur, the IEEE 802.11be standard, which is an extreme high throughput (EHT) wireless LAN technology, is being developed. The goal of the IEEE 802.11be standard may be to support a high throughput of 30 Gbps. The IEEE 802.11be standard may support techniques for reducing a transmission latency. In addition, the IEEE 802.11be standard can support a more expanded frequency bandwidth (e.g., 320 MHz bandwidth), multi-link transmission and aggregation operations including multi-band operations, multiple access point (AP) transmission operations, and/or efficient retransmission operations (e.g., hybrid automatic repeat request (HARQ) operations).

Multiple links can be used in a wireless LAN, and definition of detailed operations for the wireless LAN that support multiple links may be needed. For example, restricted target wake time (R-TWT) operations for low-latency communication may be defined. A station (STA) performing R-TWT operations may be a non-simultaneous transmit and receive (NSTR) STA and/or an enhanced multi-link single radio (EMLSR) STA. While the NSTR STA or EMLSR STA performs communication with an AP in an R-TWT SP configured on a first link, communication may not be possible on a second link. Methods for communication on the second link may be required so as not to affect communication in the R-TWT SP configured on the first link.

Meanwhile, the technologies that are the background of the present disclosure are written to improve the understanding of the background of the present disclosure and may include content that is not already known to those of ordinary skill in the art to which the present disclosure belongs.

### DISCLOSURE

### Technical Problem

The present disclosure is directed to providing a method and an apparatus for communication of an NSTR device or EMLSR device in a wireless LAN supporting R-TWT operations.

### Technical Solution

A method of a first device, according to exemplary embodiments of the present disclosure for achieving the above-described objective, may comprise: identifying a service period (SP) configured on a second link; and performing communication with a second device on a first link before a start time of the SP, wherein the communication between the first device and the second device ends before the start time of the SP.

The performing of the communication with the second device may comprise: transmitting a data frame to the second device on the first link; and receiving a reception response frame for the data frame from the second device on the first link, wherein an end time of the reception response frame is before the start time of the SP.

The performing of the communication with the second device may comprise: receiving a data frame from the second device on the first link; and transmitting a reception response frame for the data frame to the second device on the first link, wherein an end time of the reception response frame is before the start time of the SP.

The method may further comprise: transmitting a first frame to release a medium synchronization delay timer when the medium synchronization delay timer operates in the SP of the second link.

The first link and the second link may be a non-simultaneous transmit and receive (NSTR) link pair, and transmission and reception operations on the second link may be impossible while the communication between the first device and the second device is performed on the first link.

The communication between the first device and the second device may end before an offset from the start time of the SP.

When the first device is an enhanced multi-link single radio (EMLSR) device, the communication between the first device and the second device may end before an EMLSR transition delay time from the start time of the SP.

The second device may be an access point (AP) multi-link device (MLD) when the first device is a station (STA) MLD, the second device may be a STA MLD when the first device is an AP MLD, the STA MLD may include a first STA operating on the first link and a second STA operating on the second link, and the AP MLD may include a first AP operating on the first link and a second AP operating on the second link.

A first device, according to exemplary embodiments of the present disclosure for achieving the above-described objective, may comprise a processor, and the processor causes the first device to perform: identifying a service period (SP) configured on a second link; and performing communication with a second device on a first link before a start time of the SP, wherein the communication between the first device and the second device ends before the start time of the SP.

In the performing of the communication with the second device, the processor may cause the first device to perform: transmitting a data frame to the second device on the first link; and receiving a reception response frame for the data frame from the second device on the first link, wherein an end time of the reception response frame is before the start time of the SP.

In the performing of the communication with the second device, the processor may cause the first device to perform: receiving a data frame from the second device on the first link; and transmitting a reception response frame for the data frame to the second device on the first link, wherein an end time of the reception response frame is before the start time of the SP.

The processor may cause the first device to perform: transmitting a first frame to release a medium synchronization delay timer when the medium synchronization delay timer operates in the SP of the second link.

The first link and the second link may be a non-simultaneous transmit and receive (NSTR) link pair, and transmission and reception operations on the second link may be impossible while the communication between the first device and the second device is performed on the first link.

The communication between the first device and the second device may end before an offset from the start time of the SP.

When the first device is an enhanced multi-link single radio (EMLSR) device, the communication between the first device and the second device may end before an EMLSR transition delay time from the start time of the SP.

The second device may be an access point (AP) multi-link device (MLD) when the first device is a station (STA) MLD, the second device may be a STA MLD when the first device is an AP MLD, the STA MLD may include a first STA operating on the first link and a second STA operating on the second link, and the AP MLD may include a first AP operating on the first link and a second AP operating on the second link.

### Advantageous Effects

According to the present disclosure, when an R-TWT service period (SP) is configured on a second link, a first device may terminate communication on a first link before a start time of the R-TWT SP of the second link. According to the above-described operation, the communication on the first link may not affect communication in the R-TWT SP of the second link. Consequently, low-latency communication can be smoothly performed within the R-TWT SP.

### DESCRIPTION OF DRAWINGS

FIG. 1 is a block diagram illustrating a first exemplary embodiment of a communication node constituting a wireless LAN system.

FIG. 2 is a conceptual diagram illustrating a first exemplary embodiment of a multi-link configured between multi-link devices (MLDs).

FIG. 3 is a timing diagram illustrating a first exemplary embodiment of a problem according to an NSTR state within an R-TWT SP in a wireless LAN supporting multiple links.

FIG. 4A is a timing diagram illustrating a first exemplary embodiment for low-latency communication within an R-TWT SP.

FIG. 4B is a timing diagram illustrating a second exemplary embodiment for low-latency communication within an R-TWT SP.

FIG. 5A is a timing diagram illustrating a third exemplary embodiment for low-latency communication within an R-TWT SP.

FIG. 5B is a timing diagram illustrating a fourth exemplary embodiment for low-latency communication within an R-TWT SP.

FIG. 6 is a timing diagram illustrating a first exemplary embodiment of synchronous transmission in an NSTR state.

### MODE FOR INVENTION

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

In the following, a wireless communication system to which exemplary embodiments according to the present disclosure are applied will be described. The wireless communication system to which the exemplary embodiments according to the present disclosure are applied is not limited to the contents described below, and the exemplary embodiments according to the present disclosure can be applied to various wireless communication systems. A wireless communication system may be referred to as a ‘wireless communication network’.

In exemplary embodiments, ‘configuration of an operation (e.g., transmission operation)’ may mean that ‘configuration information (e.g., information element(s), parameter(s)) for the operation’ and/or ‘information indicating to perform the operation’ is signaled. ‘Configuration of an information element (e.g., parameter)’ may mean that the information element is signaled. ‘Configuration of a resource (e.g., resource region)’ may mean that setting information of the resource is signaled.

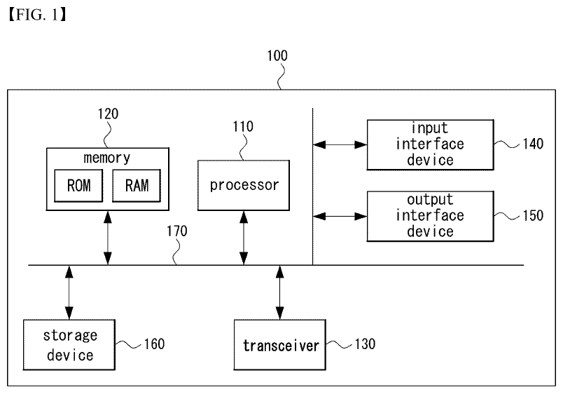

FIG. 1 is a block diagram illustrating a first exemplary embodiment of a communication node constituting a wireless LAN system.

As shown in FIG. 1, a communication node 100 may be an access point, a station, an access point (AP) multi-link device (MLD), or a non-AP MLD. An access point may refer to ‘AP’, and a station may refer to ‘STA’ or ‘non-AP STA’. An operating channel width supported by an AP may be 20 megahertz (MHz), 80 MHz, 160 MHz, or the like. An operating channel width supported by a STA may be 20 MHz, 80 MHz, or the like.

The communication node 100 may include at least one processor 110, a memory 120, and a transceiver 130 connected to a network to perform communications. The transceiver 130 may be referred to as a transceiver, a radio frequency (RF) unit, an RF module, or the like. In addition, the communication node 100 may further include an input interface device 140, an output interface device 150, a storage device 160, and the like. The respective components included in the communication node 100 may be connected by a bus 170 to communicate with each other.

However, the respective components included in the communication node 100 may be connected through individual interfaces or individual buses centering on the processor 110 instead of the common bus 170. For example, the processor 110 may be connected to at least one of the memory 120, the transceiver 130, the input interface device 140, the output interface device 150, and the storage device 160 through a dedicated interface.

The processor 110 may execute program commands stored in at least one of the memory 120 and the storage device 160. The processor 110 may refer to a central processing unit (CPU), a graphics processing unit (GPU), or a dedicated processor on which the methods according to the exemplary embodiments of the present disclosure are performed. Each of the memory 120 and the storage device 160 may be configured as at least one of a volatile storage medium and a nonvolatile storage medium. For example, the memory 120 may be configured with at least one of a read only memory (ROM) and a random access memory (RAM).

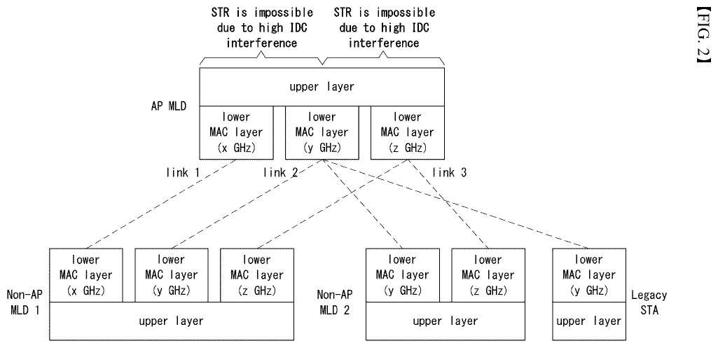

FIG. 2 is a conceptual diagram illustrating a first exemplary embodiment of a multi-link configured between multi-link devices (MLDs).

As shown in FIG. 2, an MLD may have one medium access control (MAC) address. In exemplary embodiments, the MLD may mean an AP MLD and/or non-AP MLD. The MAC address of the MLD may be used in a multi-link setup procedure between the non-AP MLD and the AP MLD. The MAC address of the AP MLD may be different from the MAC address of the non-AP MLD. AP(s) affiliated with the AP MLD may have different MAC addresses, and station(s) affiliated with the non-AP MLD may have different MAC addresses. Each of the APs having different MAC addresses within the AP MLD may be in charge of each link, and may perform a role of an independent AP.

Each of the STAs having different MAC addresses within the non-AP MLD may be in charge of each link, and may perform a role of an independent STA. The non-AP MLD may be referred to as a STA MLD. The MLD may support a simultaneous transmit and receive (STR) operation. In this case, the MLD may perform a transmission operation in a link 1 and may perform a reception operation in a link 2. The MLD supporting the STR operation may be referred to as an STR MLD (e.g., STR AP MLD, STR non-AP MLD). In exemplary embodiments, a link may mean a channel or a band. A device that does not support the STR operation may be referred to as a non-STR (NSTR) AP MLD or an NSTR non-AP MLD (or NSTR STA MLD).

The MLD may transmit and receive frames in multiple links by using a non-contiguous bandwidth extension scheme (e.g., 80 MHz+80 MHz). The multi-link operation may include multi-band transmission. The AP MLD may include a plurality of APs, and the plurality of APs may operate in different links. Each of the plurality of APs may perform function(s) of a lower MAC layer. Each of the plurality of APs may be referred to as a ‘communication node’ or ‘lower entity’. The communication node (i.e., AP) may operate under control of an upper layer (or the processor 110 shown in FIG. 1). The non-AP MLD may include a plurality of STAs, and the plurality of STAs may operate in different links. Each of the plurality of STAs may be referred to as a ‘communication node’ or ‘lower entity’. The communication node (i.e., STA) may operate under control of an upper layer (or the processor 110 shown in FIG. 1).

The MLD may perform communications in multiple bands (i.e., multi-band). For example, the MLD may perform communications using an 80 MHz bandwidth according to a channel expansion scheme (e.g., bandwidth expansion scheme) in a 2.4 GHz band, and perform communications using a 160 MHz bandwidth according to a channel expansion scheme in a 5 GHz band. The MLD may perform communications using a 160 MHz bandwidth in the 5 GHz band, and may perform communications using a 160 MHz bandwidth in a 6 GHz band. One frequency band (e.g., one channel) used by the MLD may be defined as one link. Alternatively, a plurality of links may be configured in one frequency band used by the MLD. For example, the MLD may configure one link in the 2.4 GHz band and two links in the 6 GHz band. The respective links may be referred to as a first link, a second link, and a third link. Alternatively, each link may be referred to as a link 1, a link 2, a link 3, or the like. A link number may be set by an access point, and an identifier (ID) may be assigned to each link.

The MLD (e.g., AP MLD and/or non-AP MLD) may configure a multi-link by performing an access procedure and/or a negotiation procedure for a multi-link operation. In this case, the number of links and/or link(s) to be used in the multi-link may be configured. The non-AP MLD (e.g., STA) may identify information on band(s) capable of communicating with the AP MLD. In the negotiation procedure for a multi-link operation between the non-AP MLD and the AP MLD, the non-AP MLD may configure one or more links among links supported by the AP MLD to be used for the multi-link operation. A station that does not support a multi-link operation (e.g., IEEE 802.11a/b/g/n/ac/ax STA) may be connected to one or more links of the multi-link supported by the AP MLD.

When a band separation between multiple links (e.g., a band separation between a link 1 and a link 2 in the frequency domain) is sufficient, the MLD may be able to perform an STR operation. For example, the MLD may transmit a physical layer convergence procedure (PLCP) protocol data unit (PPDU) 1 using the link 1 among multiple links, and may receive a PPDU 2 using the link 2 among multiple links. On the other hand, if the MLD performs an STR operation when the band separation between multiple links is not sufficient, in-device coexistence (IDC) interference, which is interference between the multiple links, may occur. Accordingly, when the bandwidth separation between multiple links is not sufficient, the MLD may not be able to perform an STR operation. A link pair having the above-described interference relationship may be a non-simultaneous transmit and receive (NSTR)-limited link pair. Here, the MLD may be referred to as ‘NSTR AP MLD’ or ‘NSTR non-AP MLD’.

For example, a multi-link including a link 1, a link 2, and a link 3 may be configured between an AP MLD and a non-AP MLD 1. When a band separation between the link 1 and the link 3 is sufficient, the AP MLD may perform an STR operation using the link 1 and the link 3. That is, the AP MLD may transmit a frame using the link 1 and receive a frame using the link 3. When a band separation between the link 1 and the link 2 is insufficient, the AP MLD may not be able to perform an STR operation using the link 1 and the link 2. When a band separation between the link 2 and the link 3 is not sufficient, the AP MLD may not be able to perform an STR operation using the link 2 and the link 3.

Meanwhile, in a wireless LAN system, a negotiation procedure for a multi-link operation may be performed in an access procedure between a station and an access point. A device (e.g., access point, station) that supports multiple links may be referred to as ‘multi-link device (MLD)’. An access point supporting multiple links may be referred to as ‘AP MLD’, and a station supporting multiple links may be referred to as ‘non-AP MLD’ or ‘STA MLD’. The AP MLD may have a physical address (e.g., MAC address) for each link. The AP MLD may be implemented as if an AP in charge of each link exists separately. A plurality of APs may be managed within one AP MLD. Therefore, coordination between a plurality of APs belonging to the same AP MLD may be possible. A STA MLD may have a physical address (e.g., MAC address) for each link. The STA MLD may be implemented as if a STA in charge of each link exists separately. A plurality of STAs may be managed within one STA MLD. Therefore, coordination between a plurality of STAs belonging to the same STA MLD may be possible.

For example, an AP1 of the AP MLD and a STA1 of the STA MLD may each be responsible for a first link and perform communication using the first link. An AP2 of the AP MLD and a STA2 of the STA MLD may each be responsible for a second link and perform communication using the second link. The STA2 may receive status change information for the first link on the second link. In this case, the STA MLD may collect information (e.g., status change information) received on the respective links, and control operations performed by the STA1 based on the collected information.

Hereinafter, data transmission and reception methods in a wireless LAN system will be described. Even when a method (e.g., transmission or reception of a signal) performed at a first communication node among communication nodes is described, a corresponding second communication node may perform a method (e.g., reception or transmission of the signal) corresponding to the method performed at the first communication node. That is, when an operation of a STA is described, an AP corresponding thereto may perform an operation corresponding to the operation of the STA. Conversely, when an operation of an AP is described, a STA corresponding thereto may perform an operation corresponding to the operation of the AP.

In exemplary embodiments, operations of a STA may be interpreted as operations of a STA MLD, operations of a STA MLD may be interpreted as operations of a STA, operations of an AP may be interpreted as operations of an AP MLD, and operations of an AP MLD may be interpreted as operations of an AP. A STA of a STA MLD may refer to a STA affiliated with the STA MLD, and an AP of an AP MLD may refer to an AP affiliated with the AP MLD. When a STA MLD includes a first STA operating on a first link and a second STA operating on a second link, operations of the STA MLD on the first link may be interpreted as operations of the first STA, and operations of the STA MLD on the second link may be interpreted as operations of the second STA. When an AP MLD includes a first AP operating on the first link and a second AP operating on the second link, operations of the AP MLD on the first link may be interpreted as operations of the first AP, and operations of the AP MLD on the second link may be interpreted as operations of the second AP. In exemplary embodiments, a transmission time of a frame may refer to a transmission start time or a transmission end time, and a reception time of a frame may refer to a reception start time or a reception end time. A transmission time may be interpreted as corresponding to a reception time. A time point may be interpreted as a time, and a time may be interpreted as a time point.

The AP MLD, AP, STA MLD, and/or STA may perform restricted target wake time (R-TWT) operations for low-latency communication. In the present disclosure, the R-TWT operation may be interpreted as a TWT operation, and an R-TWT service period (SP) may be interpreted as a TWT SP. The R-TWT SP and/or TWT SP may be simply expressed as ‘SP’. For example, an R-TWT SP 1 may be referred to as a first SP, and an R-TWT SP 2 may be referred to as a second SP.

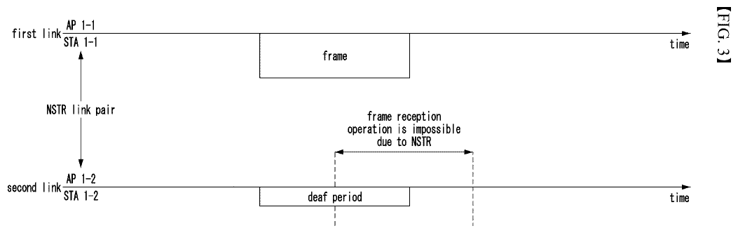

FIG. 3 is a timing diagram illustrating a first exemplary embodiment of a problem according to an NSTR state within an R-TWT SP in a wireless LAN supporting multiple links.

As shown in FIG. 3, an AP MLD 1 may include an AP 1-1 operating on a first link and an AP 1-2 operating on a second link. A STA MLD 1 may include a STA 1-1 operating on the first link and a STA 1-2 operating on the second link. The STA MLD 1 may be an NSTR device. The first link and the second link may form an NSTR link pair. Therefore, STR operations may not be possible on the first link and the second link. The AP MLD 1 may configure an R-TWT SP for low-latency communication on the second link. Low-latency communication may be performed within the R-TWT SP. Normal communication may be performed in a period other than the R-TWT SP.

The STA MLD 1 may be configured to participate in communication within the R-TWT SP configured by the AP MLD 1. In other words, the STA MLD 1 may perform communication (e.g., low-latency communication) within the R-TWT SP configured by the AP MLD 1. The STA MLD 1 (e.g., STA 1-2) may be a member of the R-TWT SP. The STA 1-1 of the STA MLD 1 may transmit a frame (e.g., data frame) to the AP 1-1 or another communication node on the first link. A period in which the transmission operation of the STA 1-1 is performed on the first link may overlap (e.g., partially overlap or fully overlap) with the R-TWT SP on the second link. A deaf (or blindness) period may occur on the second link due to the transmission operation of the STA 1-1 on the first link. In other words, due to the transmission operation of the STA 1-1, the STA 1-2 may not able to perform a channel sensing operation and/or frame reception operation. The deaf period may occur within the R-TWT SP. In the deaf period within the R-TWT SP, a channel access operation, channel sensing operation, frame transmission operation, and/or frame reception operation may be impossible. Therefore, the STA MLD 1 may not be able to perform low-latency communication within the R-TWT SP.

To solve the above-described problem (e.g., to ensure low-latency communication), it may be preferable that communication on the first link ends before the R-TWT SP of the second link. An EMLSR device (e.g., EMLSR AP, EMLSR STA) may terminate the communication before the R-TWT SP by additionally considering a transition delay, which is a time required for link switching of a reception radio. The transition delay may be an EMLSR transition delay.

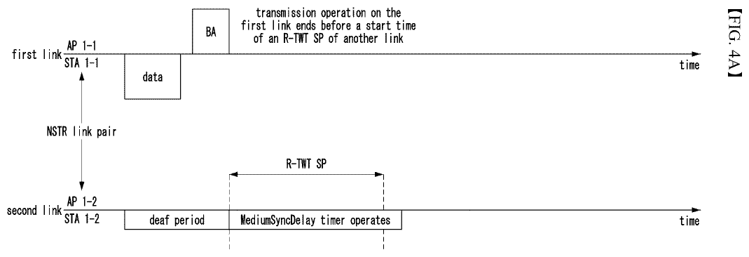

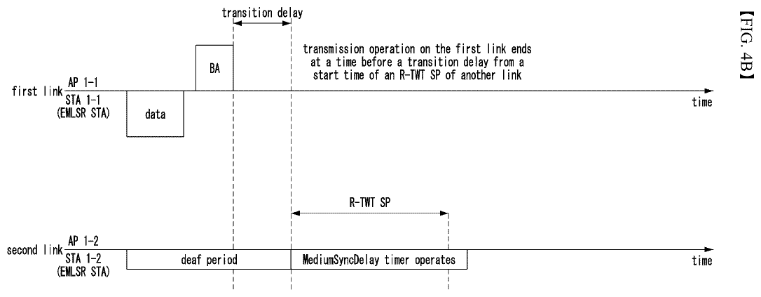

FIG. 4A is a timing diagram illustrating a first exemplary embodiment for low-latency communication within an R-TWT SP.

As shown in FIG. 4A, the AP MLD 1 may include the AP 1-1 operating on the first link and the AP 1-2 operating on the second link. The STA MLD 1 may include the STA 1-1 operating on the first link and the STA 1-2 operating on the second link. The STA MLD 1 may be an NSTR device. The first link and the second link may form an NSTR link pair. The AP MLD 1 may configure an R-TWT SP on the second link. The STA MLD 1 may identify the R-TWT SP configured by the AP MLD 1. The AP MLD 1 may generate a beacon frame including an R-TWT information element (e.g., R-TWT IE) to configure the R-TWT SP, and may transmit the beacon frame. The STA MLD 1 may receive the beacon frame of the AP MLD 1 and may identify the R-TWT SP indicated by the beacon frame. The STA MLD 1 (e.g., STA 1-2) may be a member of the R-TWT SP of the second link. The STA 1-1 of the STA MLD 1 may terminate a transmission operation of a frame on the first link before a start time of the R-TWT SP or a time before an offset from the start time of the R-TWT SP. In the present disclosure, the start time of the R-TWT SP may be interpreted to include the time before the offset from the start time of the R-TWT SP.

For example, the STA 1-1 may adjust the length of the frame so that ‘the transmission operation of the frame (e.g., data frame)+short inter frame space (SIFS)+reception operation of a reception response frame’ on the first link ends before the start time of the R-TWT SP of the second link. In the present disclosure, the reception response frame may be an acknowledgement (ACK) frame or a block ACK (BA) frame. Accordingly, a deaf period caused by the communication on the first link can be terminated (e.g., released, removed) before the start time of the R-TWT SP of the second link, and low-latency communication of the STA MLD 1 within the R-TWT SP of the second link can be ensured.

FIG. 4B is a timing diagram illustrating a second exemplary embodiment for low-latency communication within an R-TWT SP.

As shown in FIG. 4B, the AP MLD 1 may include the AP 1-1 operating on the first link and the AP 1-2 operating on the second link. The STA MLD 1 may include the STA 1-1 operating on the first link and the STA 1-2 operating on the second link. The STA MLD 1 may be an EMLSR device. The EMLSR device (e.g., EMLSR STA) may perform communication on one link. In other words, the EMLSR device may not be able to perform communication on multiple links simultaneously. Listening operations of the EMLSR device may be performed on multiple links, but EMLSR operations of the EMLSR device may be performed on one link. Therefore, a deaf period may occur on the second link while the STA MLD 1 performs communication on the first link. In other words, due to the communication operation of the STA 1-1, the STA 1-2 may not be able to perform a channel sensing operation and/or frame reception operation. The AP MLD 1 may configure an R-TWT SP on the second link. The STA MLD 1 may identify the R-TWT SP configured by the AP MLD 1. The AP MLD 1 may generate a beacon frame including an R-TWT information element (e.g., R-TWT IE) to configure the R-TWT SP, and transmit the beacon frame. The STA MLD 1 may receive the beacon frame of the AP MLD 1, and identify the R-TWT SP indicated by the beacon frame. The STA MLD 1 (e.g., STA 1-2) may be a member of the R-TWT SP of the second link.

The STA 1-1 of the STA MLD 1 may terminate a transmission operation of a frame on the first link before a time before a transition delay (e.g., EMLSR transition delay) from a start time of the R-TWT SP or a time before [transition delay+offset] from the start time of the R-TWT SP. In the present disclosure, the time before the transition delay from the start time of the R-TWT SP may be interpreted to include the time before [transition delay+offset] from the start time of the R-TWT SP.

For example, the STA 1-1 may adjust the length of the frame, so that ‘the transmission operation of the frame (e.g., data frame)+SIFS+reception operation of a reception response frame+transition delay’ on the first link end before the start time of the R-TWT SP of the second link. In the present disclosure, the reception response frame may be an ACK frame or a BA frame. Therefore, the deaf period caused by communication on the first link can end before the start time of the R-TWT SP of the second link, and low-latency communication of the STA MLD 1 within the R-TWT SP of the second link can be ensured.

If a deaf period occurs due to an EMLSR operation or NSTR state of the STA MLD 1, and the deaf period is equal to or longer than a preset time, a MediumSyncDelay timer may operate even after the deaf period ends. The MediumSyncDelay timer may be referred to as a medium synchronization delay timer, synchronization timer, or delay timer. In a period corresponding to the MediumSyncDelay timer, transmission operations of communication nodes (e.g., MLD, AP, STA) may be impossible. A value of the MediumSyncDelay timer may be preset. If the MediumSyncDelay timer operates within the R-TWT SP, low-power communication of communication nodes within the R-TWT SP may be restricted. To solve the above-described problem, the AP MLD 1 may release the MediumSyncDelay timer of the STA MLD 1 by transmitting an arbitrary data frame, QOS Null frame, and/or trigger frame within the R-TWT SP.

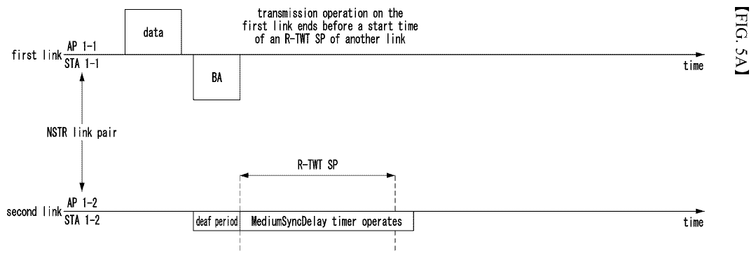

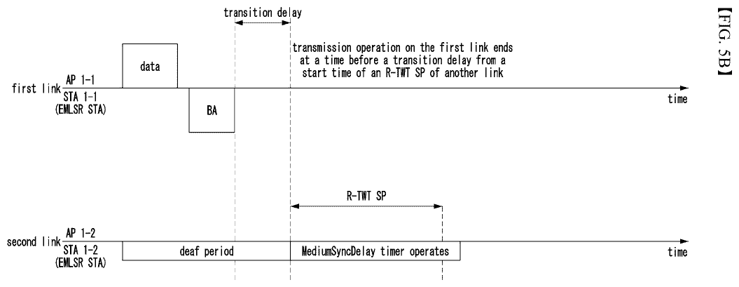

FIG. 5A is a timing diagram illustrating a third exemplary embodiment for low-latency communication within an R-TWT SP.

As shown in FIG. 5A, the AP MLD 1 may include the AP 1-1 operating on the first link and the AP 1-2 operating on the second link. The STA MLD 1 may include the STA 1-1 operating on the first link and the STA 1-2 operating on the second link. The STA MLD 1 may be an NSTR device. The STA MLD 1 may be an NSTR device. The first link and the second link may form an NSTR link pair. In other words, due to a transmission operation of the STA 1-1, the STA 1-2 may not be able to perform a channel sensing operation and/or frame reception operation. The AP MLD 1 may configure an R-TWT SP on the second link. The STA MLD 1 may identify the R-TWT SP configure by the AP MLD 1. The STA MLD 1 (e.g., STA 1-2) may be a member of the R-TWT SP on the second link. The AP MLD 1 may generate a beacon frame including an R-TWT information element (e.g., R-TWT IE) to configure the R-TWT SP, and transmit the beacon frame. The STA MLD 1 may receive the beacon frame of the AP MLD 1, and identify the R-TWT SP indicated by the beacon frame.

The AP 1-1 of the AP MLD 1 may terminate a transmission operation of a frame on the first link before a start time of the R-TWT SP or a time before an offset from the start time of the R-TWT SP. For example, the AP 1-1 may adjust the length of the frame so that ‘the transmission operation of the frame (e.g., data frame)+SIFS+reception operation of a reception response frame’ on the first link ends before the start time of the R-TWT SP of the second link. Accordingly, a deaf period caused by the communication on the first link can be terminated (e.g., released, removed) before the start time of the R-TWT SP of the second link, and the low-latency communication of the STA MLD 1 within the R-TWT SP of the second link can be ensured.

FIG. 5B is a timing diagram illustrating a fourth exemplary embodiment for low-latency communication within an R-TWT SP.

As shown in FIG. 5B, the AP MLD 1 may include the AP 1-1 operating on the first link and the AP 1-2 operating on the second link. The STA MLD 1 may include the STA 1-1 operating on the first link and the STA 1-2 operating on the second link. The STA MLD 1 may be an EMLSR device. The EMLSR device (e.g., EMLSR STA) may perform communication on one link. In other words, the EMLSR device may not be able to perform communication on multiple links simultaneously. Listening operations of the EMLSR device may be performed on multiple links, but EMLSR operations of the EMLSR device may be performed on one link. Therefore, a deaf period may occur on the second link while communication between the AP MLD 1 and the STA MLD 1 is performed on the first link. The AP MLD 1 may configure an R-TWT SP on the second link. The STA MLD 1 may identify the R-TWT SP configured by the AP MLD 1. The STA MLD 1 (e.g., STA 1-2) may be a member of the R-TWT SP on the second link. The AP MLD 1 may generate a beacon frame including an R-TWT information element (e.g., R-TWT IE) to configure the R-TWT SP, and transmit the beacon frame. The STA MLD 1 may receive the beacon frame of the AP MLD 1, and identify the R-TWT SP indicated by the beacon frame.

The AP 1-1 of the AP MLD 1 may terminate a transmission operation of a frame on the first link before a time before a transition delay (e.g., EMLSR transition delay) from a start time of the R-TWT SP or a time before [transition delay+offset] from the start time of the R-TWT SP. For example, the AP 1-1 may adjust the length of the frame so that ‘the transmission operation of the frame (e.g., data frame)+SIFS+reception operation of a reception response frame+transition delay’ on the first link ends before the start time of the R-TWT SP on the second link. Accordingly, the deaf period caused by the communication on the first link can be terminated before the start time of the R-TWT SP on the second link, and the low-latency communication of the STA MLD 1 within the R-TWT SP of the second link can be ensured

If a deaf period occurs due to the EMLSR operation or NSTR state of the STA MLD 1 and the deaf period is equal to or longer than a preset time, a MediumSyncDelay timer may operate even after the deaf period ends. Transmission operations of communication nodes (e.g., MLD, AP, STA) may be impossible in a period corresponding to the MediumSyncDelay timer. A value of the MediumSyncDelay timer may be preset. While the MediumSyncDelay timer operates within the R-TWT SP, low-power communication of communication nodes within the R-TWT SP may be restricted. To solve the above-described problem, the AP MLD 1 may release the MediumSyncDelay timer of the STA MLD 1 by transmitting an arbitrary data frame, QoS Null frame, and/or trigger frame within the R-TWT SP.

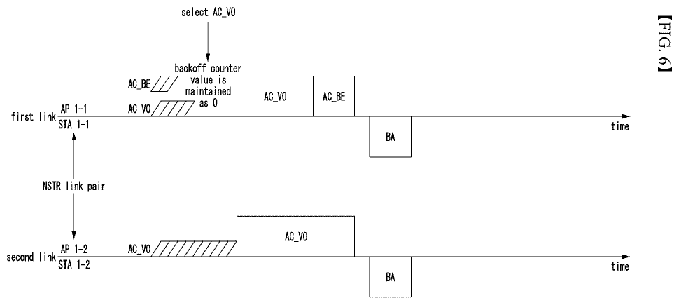

FIG. 6 is a timing diagram illustrating a first exemplary embodiment of synchronous transmission in an NSTR state.

As shown in FIG. 6, the AP MLD 1 may include the AP 1-1 operating on the first link and the AP 1-2 operating on the second link. The STA MLD 1 may include the STA 1-1 operating on the first link and the STA 1-2 operating on the second link. The STA MLD 1 may be an NSTR device. The first link and the second link may be form an NSTR link pair.

The AP MLD may perform backoff operations on the first link and the second link for synchronous transmission of frames. The STA MLD may perform backoff operations on the first link and the second link for synchronous transmission of frames. When synchronous transmission is performed, start times (e.g., transmission start times) of the frames on the first link and the second link may be the same, and end times (e.g., transmission end times) of the frames on the first link and the second link may be the same. The backoff operation may be an enhanced distributed channel access function (EDCAF) operation according to an access category (AC). The ACs may be as shown in Table 1 below.

TABLE 1

| Priority | AC | Content |
|---|---|---|
| Lowest | AC_BK | Background |
| ↑ | AC_BE | Best effort |
| ↓ | AC_VI | Video |
| Highest | AC_VO | Voice |

AC_BK may indicate background data, AC_BE may indicate data transmitted in a best effort manner, AC_VI may indicate video data, and AC_VO may indicate voice data.

If an EDCAF backoff counter value on the first link is 0 and the backoff operation on the second link is not completed, the AP 1-1 may wait for a transmission operation on the first link until the backoff operation on the second link is completed. In other words, the AP 1-1 may keep the EDCAF backoff counter value on the first link as 0 until the backoff operation on the second link is completed. The EDCAF backoff counter value being 0 may mean that the backoff operation is completed. The backoff operation being completed may mean that the EDCAF backoff counter value is 0.

Before the backoff operation on the second link is completed, the EDCAF backoff counter value for AC_BE on the first link may become 0, and the EDCAF backoff counter value for AC_VO on the first link may become 0. The EDCAF backoff counter values for multiple ACs may become 0. If the backoff counter value on the second link becomes 0 (e.g., if the backoff operation on the second link succeeds), the AP MLD (e.g., AP 1-1) and/or the STA MLD (e.g., STA 1-1) may select one AC from among ACs (e.g., AC_BE and AC_VO) for which the backoff operation on the first link succeeds. The operation of selecting one AC on the first link may be performed even before the backoff operation on the second link succeeds. On the first link, the AP MLD (e.g., AP 1-1) and/or STA MLD (e.g., STA 1-1) may select AC_VO having a higher priority among AC_BE and AC_VO. The length of an AC_VO frame transmitted on the first link may be shorter than the length of a frame (e.g., AC_VO frame) transmitted on the second link. In other words, a synchronization of the AC_VO frame on the first link may not match a synchronization of the AC_VO frame on the second link. The AC_VO frame may be a frame including data corresponding to AC_VO.

For synchronous transmission on the first link and the second link, the communication node (e.g., AP MLD 1) may match start and end times of the frame on the first link with start and end times of the frame on the second link. To match the end times of the frames on the first link and the second link, the length of the frame on the first link may be adjusted. For example, the AP MLD 1 (e.g., AP 1-1) may add padding bit(s) to the frame on the first link. If the length of the frame on the first link is shorter than the length of the frame on the second link, the AP MLD 1 (e.g., AP 1-1) may transmit an additional frame on the first link to match the end times of the frames on the first link and the second link. For example, the AP 1-1 may transmit a data frame including an AC_VO frame and an AC_BE frame on the first link. The data frame including the AC_VO frame and AC_BE frame may have an aggregated (A)-MPDU form. In this case, the AC_BE frame that is not selected by the AP MLD 1 (e.g., AP 1-1) in the AC selection procedure may also be transmitted on the first link. The operation of transmitting the AC_VO frame and AC_BE frame may be performed when there is a remaining transmit opportunity (TXOP) for AC_VO. In other words, the maximum length of the ‘AC_VO frame+AC_BE frame’ may not exceed a TXOP limit of AC_VO. The ‘AC_VO frame+AC_BE frame’ having a length exceeding the TXOP limit of AC_VO may not be transmitted. The start and end times of the ‘AC_VO frame+AC_BE frame’ on the first link may be identical to the start and end times of the AC_VO frame on the second link, respectively.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A method of a first device, comprising:
identifying a service period (SP) configured on a second link; and
performing communication with a second device on a first link before a start time of the SP,
wherein the communication between the first device and the second device ends before the start time of the SP.

2. The method of claim 1, wherein the performing of the communication with the second device comprises:
transmitting a data frame to the second device on the first link; and
receiving a reception response frame for the data frame from the second device on the first link,
wherein an end time of the reception response frame is before the start time of the SP.

3. The method of claim 1, wherein the performing of the communication with the second device comprises:
receiving a data frame from the second device on the first link; and
transmitting a reception response frame for the data frame to the second device on the first link,
wherein an end time of the reception response frame is before the start time of the SP.

4. The method of claim 1, further comprising: transmitting a first frame to release a medium synchronization delay timer when the medium synchronization delay timer operates in the SP of the second link.

5. The method of claim 1, wherein the first link and the second link are a non-simultaneous transmit and receive (NSTR) link pair, and transmission and reception operations on the second link are impossible while the communication between the first device and the second device is performed on the first link.

6. The method of claim 1, wherein the communication between the first device and the second device ends before an offset from the start time of the SP.

7. The method of claim 1, wherein when the first device is an enhanced multi-link single radio (EMLSR) device, the communication between the first device and the second device ends before an EMLSR transition delay time from the start time of the SP.

8. The method of claim 1, wherein the second device is an access point (AP) multi-link device (MLD) when the first device is a station (STA) MLD, the second device is a STA MLD when the first device is an AP MLD, the STA MLD includes a first STA operating on the first link and a second STA operating on the second link, and the AP MLD includes a first AP operating on the first link and a second AP operating on the second link.

9. A first device comprising a processor, wherein the processor causes the first device to perform:
identifying a service period (SP) configured on a second link; and
performing communication with a second device on a first link before a start time of the SP,
wherein the communication between the first device and the second device ends before the start time of the SP.

10. The first device of claim 9, wherein in the performing of the communication with the second device, the processor causes the first device to perform:
transmitting a data frame to the second device on the first link; and
receiving a reception response frame for the data frame from the second device on the first link,
wherein an end time of the reception response frame is before the start time of the SP.

11. The first device of claim 9, wherein in the performing of the communication with the second device, the processor causes the first device to perform:
receiving a data frame from the second device on the first link; and
transmitting a reception response frame for the data frame to the second device on the first link,
wherein an end time of the reception response frame is before the start time of the SP.

12. The first device of claim 9, wherein the processor causes the first device to perform: transmitting a first frame to release a medium synchronization delay timer when the medium synchronization delay timer operates in the SP of the second link.

13. The first device of claim 9, wherein the first link and the second link are a non-simultaneous transmit and receive (NSTR) link pair, and transmission and reception operations on the second link are impossible while the communication between the first device and the second device is performed on the first link.

14. The first device of claim 9, wherein the communication between the first device and the second device ends before an offset from the start time of the SP.

15. The first device of claim 9, wherein when the first device is an enhanced multi-link single radio (EMLSR) device, the communication between the first device and the second device ends before an EMLSR transition delay time from the start time of the SP.

16. The first device of claim 9, wherein the second device is an access point (AP) multi-link device (MLD) when the first device is a station (STA) MLD, the second device is a STA MLD when the first device is an AP MLD, the STA MLD includes a first STA operating on the first link and a second STA operating on the second link, and the AP MLD includes a first AP operating on the first link and a second AP operating on the second link.
